(19) United States
(12) Patent Application Publication
(10) Pub. No.: US 2025/0218178 A1
(43) Pub. Date: Jul. 3, 2025

(54) ELECTRIC VEHICLE DATA BASED VIDEO COMPOSITION AND CONTENT AUGMENTATION

(71) Applicant: Rivian IP Holdings, LLC, Irvine, CA (US)

(72) Inventors: Fai Yeung, Palo Alto, CA (US); Michael Adkins Knott, San Mateo, CA (US); Abhiram Krishnan, Surrey (CA); Brian K. Chan, Santa Clara, CA (US)

(73) Assignee: Rivian IP Holdings, LLC, Irvine, CA (US)

(21) Appl. No.: 18/402,336

(22) Filed: Jan. 2, 2024

(51) Int. Cl. G06V 20/40; G06V 10/774; G06V 20/56

(52) U.S. Cl. CPC G06V 20/41; G06V 10/774; G06V 20/49; G06V 20/56

(57) ABSTRACT

Technical solutions present systems and methods for generating a composite video of a trip and inserting augmented content using AI modeling and vehicle data. A solution can identify a plurality of videos taken from a vehicle between a first time and a second time. The solution can identify, for the plurality of videos, a plurality of video fragments, each one of which corresponding to data of the vehicle at a time interval of a plurality of time intervals between the first time and the second time. The solution can determine, based on the plurality of video fragments input into a model, a type of scene for each video fragment and select, a set of video fragments based on the respective data and the respective type of scene of a plurality of sets of video fragments to generate a composite video using the set of video fragments.

### INTRODUCTION

Vehicles, such as electric vehicles (EVs), can include cameras capturing videos of various drives or road trips. Videos can be stored in the storage devices which can have limited storage capacity.

### SUMMARY

Cameras integrated in different areas of EVs can be used to record users' drive sessions, such as family road trips, off-roading adventures, or cross-country journeys. Users can benefit from using video footage captured by these cameras to create memorable video journals of their trips. While preparing the videos, the user can also benefit from augmenting the content of the videos with animated or simulated context-suitable features. However, sorting through hours of video recordings to identify the relevant video fragments to include in a video journal or to augment the video content using augmenting content can be both challenging and time consuming, as well as computationally and resource demanding. To overcome these challenges, the technical solutions of the present disclosure combine EV data and artificial intelligence (AI) modeling to identify relevant video fragments and generate a composite video journal of a drive session, while also allowing for augmenting the composite videos with context-suitable animated or simulated animated or simulated content.

The technical solutions can utilize EV data and the available capacity of the storage devices to identify and protect from deletion the most valuable fragments of the video files, allowing for their subsequent viewing and use. As storage devices storing the EV videos can have a limited capacity and EV cameras continue to operate and capture additional videos due to user's continued EV operation, some of the older video files can be deleted by systems managing storage data in order to make room for the new video files. However, deleting video files of particular interest to the user can hinder user experience and result in loss of valuable data. The technical solutions of the present disclosure overcome this challenge by leveraging EV contextual data and the monitored storage capacity to identify and protect from deletion the most valuable fragments of the video records, which can then be used to compile videos of particular events or experiences.

An aspect is directed to a system, such as a data processing system. Data processing system can include one or more processors coupled with memory to identify a plurality of videos taken from a vehicle, each video of the plurality of videos captured between a first time and a second time. The one or more processors can be configured to identify, for the plurality of videos, a plurality of video fragments. Each video fragment of the plurality of video fragments can correspond to data of the vehicle at a time interval of a plurality of time intervals between the first time and the second time for each video of the plurality of videos. The one or more processors can be configured to determine, based on the plurality of video fragments input into a model trained on a data of a plurality of scenes, a type of scene for each video fragment of the plurality of video fragments. The one or more processors can be configured to select, a set of video fragments based on the respective data and the respective type of scene of a plurality of sets of video fragments. The one or more processors can be configured to generate a composite video using the set of video fragments.

An aspect is directed to a data processing system in which the one or more processors are configured to identify a feature of the composite video. The one or more processors can be configured to determine, based at least on the composite video input into a model trained using machine learning on a data comprising a plurality of features in the plurality of scenes, a scene of the composite video corresponding to the feature. The one or more processors can be configured to select, based on the scene, content to insert into the composite video. The one or more processors can be configured to provide, for display, the composite video including the content.

An aspect is directed to a method. The method can include one or more processors coupled with memory identifying a plurality of videos taken from a vehicle. Each video of the plurality of videos can be captured between a first time and a second time. The method can include the one or more processors identifying, for the plurality of videos, a plurality of video fragments. Each video fragment of the plurality of video fragments can correspond to data of the vehicle during a time interval of a plurality of time intervals between the first time and the second time for each video of the plurality of videos. The method can include determining, by the one or more processors, based on the plurality of video fragments input into a model trained on a data of a plurality of scenes, a type of scene for each video fragment of the plurality of video fragments. The method can include selecting, by the one or more processors, a set of video fragments based on the respective data and the respective type of scene of a plurality of sets of video fragments. The method can include generating, by the one or more processors, a composite video using the set of video fragments.

An aspect is directed to a method for including a generated augmented reality or virtual reality content into a video, such as the composite video. The method can include identifying, by the one or more processors, a feature of the composite video. The method can include determining, by the one or more processors based at least on the composite video input into a model trained using machine learning on a data comprising a plurality of features in the plurality of scenes, a scene of the composite video corresponding to the feature. The method can include selecting, by the one or more processors based on the scene, content to insert into the composite video. The method can include providing, by the one or more processors for display, the composite video including the content.

An aspect is directed to a non-transitory computer-readable media having processor readable instructions. The instructions can be such that, when executed, cause a processor to identify a plurality of videos taken from a vehicle. Each video of the plurality of videos can be captured between a first time and a second time. The instructions can be such that, when executed, cause a processor to identify, for the plurality of videos, a plurality of video fragments. Each video fragment of the plurality of video fragments can correspond to data of the vehicle at a time interval of a plurality of time intervals between the first time and the second time for each video of the plurality of videos. The instructions can be such that, when executed, cause a processor to determine, based on the plurality of video fragments input into a model trained on a data of a plurality of scenes, a type of scene for each video fragment of the plurality of video fragments. The instructions can be such that, when executed, cause a processor to select, a set of video fragments based on the respective data and the respective type of scene of a plurality of sets of video fragments. The instructions can be such that, when executed, cause a processor to generate a composite video using the set of video fragments.

The instructions can be such that, when executed, cause a processor to identify a feature of the composite video. The instructions can be such that, when executed, cause a processor to determine, based at least on the composite video input into a model trained using machine learning on a data comprising a plurality of features in the plurality of scenes, a scene of the composite video corresponding to the feature. The instructions can be such that, when executed, cause a processor to select, based on the scene, content to insert into the composite video. The instructions can be such that, when executed, cause a processor to provide, for display, the composite video including the content.

An aspect is directed to a system. The system can include one or more processors coupled with memory to identify an amount of available capacity of a storage device of a vehicle. The storage device can store a plurality of video fragments of one or more videos taken from the vehicle. Each of the plurality of video fragments can be assigned a priority score. The one or more processors can be configured to determine, for each of the plurality of video fragments, a retention value based on the priority score of the respective video fragment and the amount of available capacity. The one or more processors can be configured to select for deletion at least one of the plurality of video fragments whose respective retention value does not exceed a threshold for retention. The one or more processors can be configured to delete from the storage device the at least one of the plurality of video fragments to increase the available capacity of the storage device.

An aspect is directed to a method. The method can include identifying, by one or more processors coupled with memory, an amount of available capacity of a storage device of a vehicle. The storage device can store a plurality of video fragments of one or more videos taken from the vehicle. Each of the plurality of video fragments can be assigned a priority score. The method can include determining, by the one or more processors, for each of the plurality of video fragments, a retention value based on the priority score of the respective video fragment and the amount of available capacity. The method can include selecting for deletion, by the one or more processors, at least one of the plurality of video fragments whose respective retention value does not exceed a threshold for retention. The method can include deleting, by the one or more processors, from the storage device the at least one of the plurality of video fragments to increase the available capacity of the storage device.

An aspect is directed to a non-transitory computer-readable media having processor readable instructions, such that, when executed, cause at least one processor to identify an amount of available capacity of a storage device of a vehicle. The storage device can store a plurality of video fragments of one or more videos taken from the vehicle. Each of the plurality of video fragments can be assigned a priority score. The instructions, when executed, can cause the at least one processor to determine, for each of the plurality of video fragments, a retention value based on the priority score of the respective video fragment and the amount of available capacity. The instructions, when executed, can cause the at least one processor to select for deletion at least one of the plurality of video fragments whose respective retention value does not exceed a threshold for retention. The instructions, when executed, can cause the at least one processor to delete from the storage device the at least one of the plurality of video fragments to increase the available capacity of the storage device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle.

FIG. 2 depicts a block diagram of an example system for EV video composition and content editing using AI modeling and generated dynamic content.

FIG. 3 illustrates a block diagram of an example system for using AI modeling and EV data to select video fragments for generating a composite video of a drive session.

FIG. 4 illustrates a block diagram of an example media referencing function that can be used by systems of the technical solutions.

FIG. 5 illustrates block diagram examples of video formatting and organization that can be utilized by the technical solutions.

FIG. 6 illustrates a flow diagram of an example method generating a composite video of a drive session using AI modeling, EV data, fragment bias and user preferences for selection of video fragments.

FIG. 7 is a flow diagram illustrating an example method of generating a composite video of a drive session using at least AI modeling and EV data for selection of video fragments.

FIG. 8 illustrates a block diagram of an example system for managing a storage device available capacity by protecting from deletion video fragments of higher priority using a scoring system based on data of the vehicle.

FIG. 9 illustrates a block diagram of an example system for managing the storage on the storage device based on the available capacity of a storage device and priority scores of the video fragments.

FIG. 10 illustrates an example flow diagram of a method of managing available capacity of a storage device while protecting from deletion video fragments of higher priority using a scoring system based on data of the vehicle and the available capacity.

FIG. 11 is a block diagram illustrating an example architecture for a computer system that can be employed to implement elements of the systems and methods described and illustrated herein.

### DETAILED DESCRIPTION

Following below are more detailed descriptions of various concepts related to, and implementations of, methods, apparatuses, and systems of EV data based video composition and storage control. The various concepts introduced above and discussed in greater detail below may be implemented in any of numerous ways.

Electric vehicles (EVs) described herein can include one or more cameras integrated into different areas of an EV. Each of the cameras can be directed to a different direction from the EV and cover a different view. Each of the EV cameras can record in a continuous fashion video footage of the user's trips, including off-roading trips, cross-country journeys or family vacations. A user could benefit from using the EV video footage compile some of the more memorable or most important moments or scenes of the drive into a single composite video (e.g., summarizing the trip). The user may also find it beneficial to modify or augment the EV video recordings using superimposed visual or dynamic content, such as, for example, augmented reality (AR) or virtual reality (VR) content, including animations or characters generated in accordance with the general context, background or scenery of the recorded video scenes. However, as EV cameras capture video footage of the entire drive session without interruptions, it can be challenging and time consuming, as well as computationally and resource intensive to sort through the many hours of the video footage and identify the specific video fragments to incorporate into a composed video journal of the trip. It can also be computationally and resource intensive to design and insert into relevant parts of the videos superimposed content.

Overcoming these challenges, the present technical solutions can utilize EV data providing context of the EV trip corresponding to the timing of the video footage together with artificial intelligence (AI) modeling to identify the relevant video fragments from different EV cameras to use to generate a composite video of the drive session. The technical solutions can also utilize an AI model to incorporate into the videos visual or dynamic content, such as AR or VR content, that can be generated or selected based on the context or scenery of the recorded trip. For example, the technical solutions can utilize AI models that can process scenes from the video files in the context of the timestamped contextual EV data to determine or infer the type of the trip undertaken and to select the most relevant video fragments to use for the given composite video journal of the trip. For example, the technical solutions can include an analyzer using the EV contextual data, the type of background scenery of the videos, along with a bias to reduce the rapid scene changes while identifying specific video fragments to include in the compiled video journal. A scene selector can extract selected video fragments form the videos, apply time shifting technique to automatically speed up content where applicable, overlay vehicle data on the content.

The technical solutions can leverage EV data and the video content to identify video fragments to protect from deletion by a storage management system seeking to delete data to create space for new video footage. The technical solutions can use a scoring system to assign and mark the level of priority or importance to various video fragments captured from the EV video cameras as they are being stored into the storage devices. As the storage devices run out of storage capacity and seek to create additional space for storing new video files, the technical solutions can utilize the priority values of the recordings and the remaining storage capacity to determine which video segments to delete, and which to keep in storage. For instance, a deletion function (e.g., a cost function for management of storage capacity) can be used to determine, based on a current remaining storage capacity and the score (e.g., of priority or importance) of each of the stored video segments, which segments to delete and which to remain stored for use in compilation of a new video file.

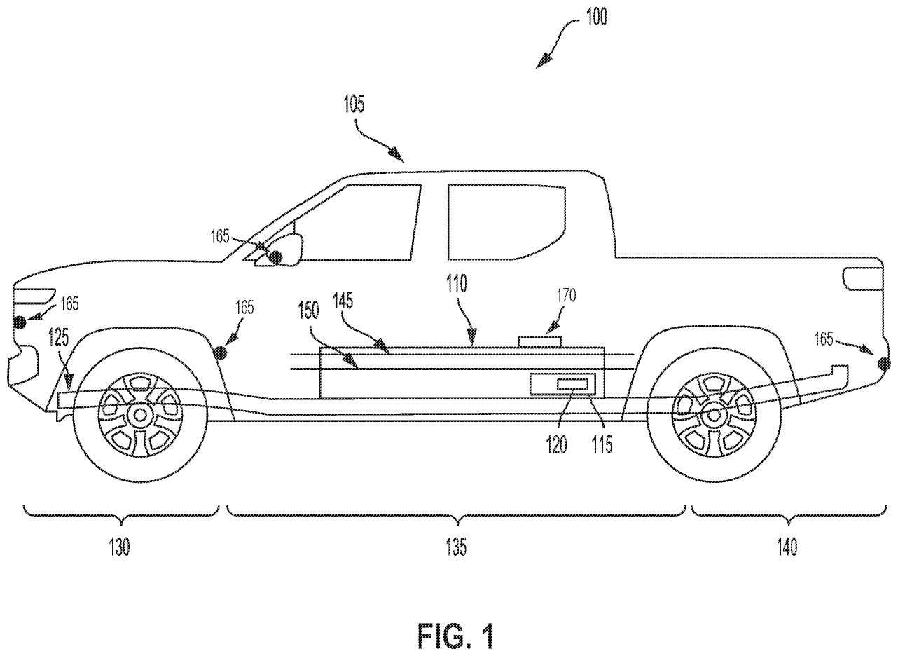

FIG. 1 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Yet, it should also be noted that battery pack 110 may also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

EV 105 can include one or more cameras 165 distributed around the EV 105 for capturing media data (e.g., images or video files) and storing the media data on the storage device 170. Cameras 165 can be installed, positioned or located in various parts of the EV 105, such as at front of the EV 105 (e.g., on, or within, the front bumper), at the dashboard or the windshield of the EV 105, at the back of the EV 105 (e.g., on, or within, the rear bumper), or on either side of the vehicle (e.g., on the body of the EV next to the wheels and/or at the side view mirrors). Cameras 165 can be turned or facing toward different directions, thereby capturing videos or photos across various viewing areas or directions from the EV 105. Cameras 165 can be communicatively and/or physically coupled with storage device 170, which can include any device (e.g., a hard disk drive, solid state drive, network attached storage or cloud storage) that can have a limited storage capacity to store all of the media data (e.g., video files) captured by the cameras 165 of the EV 105.

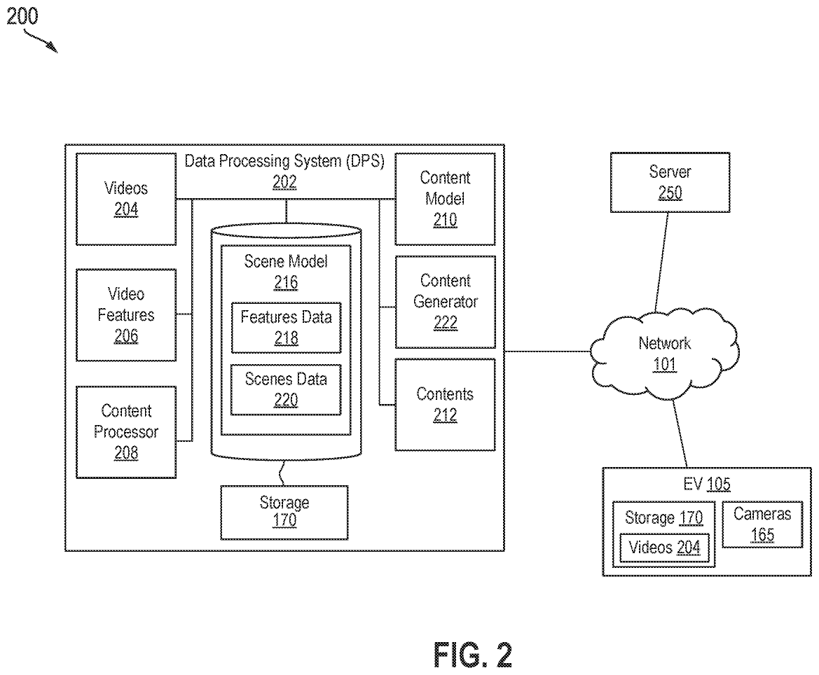

FIG. 2 depicts a block diagram of an example system 200 for EV video composition and content editing using ML based video fragment analysis. Example system 200 can utilize ML or AI models to generate or select visual or dynamic content, such as AR or VR content (e.g., animations or simulations). The visual or dynamic content can be inserted into video files, such as videos 204 or composite videos 372, based at least on the features or scenes of the videos 204.

Example system 200 can include one or more EVs 105, servers 250 and data processing systems (DPSs) 202 that can exchange communications (e.g., videos 204 or other data) over a network 101. EV 105 can include one or more cameras 165 and storage devices 170 for recording and storing videos 204 on the EV 105. DPS 202 can include one or more videos 204, video features 206, content processors 208, content models 210, contents 212, storages 170, scene models 216 and content generators 222. Scene model 216 can include one or more features data 218 and scenes data 220 on which the scene model 216 can be trained.

For example, a DPS 202, which can be deployed or located on an EV 105 or on a remote server 250 across a network 101, can include the functionality for processing videos 204 captured by cameras 165. Each camera 165 of the plurality of cameras 165 can continuous a separate video 204, capturing a continuous recording of a trip over a particular time interval of the duration of the trip or drive session. Videos 204 can include video features (e.g., details, objects or locations) captured by various cameras 165 over the course of the drive session. Scene model 216 can include machine learning (ML) or AI functionality trained using features data (e.g., plurality of features in a plurality of videos) and scenes data 220 (e.g., plurality of scenes in a plurality of videos) to detect or identify a particular scene or feature in the videos 204 captured during a drive session. Based on identified scenes and video features, content model 210 can identify a type of content 212 to generate for the video 204. Content generator 222 can generate the content 212 (e.g., AR or VR features or characters) and the content processor 208 can process the generated content 212 to insert it into the videos 204 to provide the augmented videos 204.

Data processing system (DPS) 202 can include any combination of hardware and software for processing videos 204. DPS 202 can include or utilize ML or AI modeling to modify the content of the videos 204, generate composite videos (e.g., 372) from various fragments of videos 204. DPS 202 can be included, deployed on or executed by EV 105 (e.g., computing system of EV 105), server 250, cloud-based system (e.g., software as a service) or any other device or service. DPS 202 can include a series of functionalities for processing videos 204 from cameras 165. DPS 202 can leverage ML and AI techniques to detect and identify specific scenes, scene types, objects, or features within the video footage. By analyzing a combination of feature data 218 and scene data 220 from the recorded videos 204, DPS 202 can identify, detect or recognize various elements in the contents 212 of the videos 204. DPS 202 can include a content model 210 that can identify the most suitable type of content 212 to include into the videos 204. DPS 202 can further manage storage of video fragments or video files in storage devices based on analysis of at least available capacity of the storage devices 170 and EV data 310, as well as any other functionality, such as AI or ML scene model analysis or content analysis. Content 212 can include, for example, AR or VR elements or features, including digital features, objects, or characters. DPS 202 can include a content generator 222 to create the selected content 212 and a content processor 208 for seamlessly embedding such content 212 into the original videos 204.

Network 101 can include any interconnected system of devices or computers allowing communication interfaces or components of EV 105, DPS 202, and server 250, to seamlessly communicate and exchange data, including video files (e.g., videos 204), among themselves. Network 101 can include any type and form of network, such as wired or wireless networks. Wired networks can include Ethernet or fiber-optic networks and can use or include physical cables to transmit data at high speeds in fixed installations. Network 101 can include wireless networks, which can utilize wireless, for example radio signals, for data transmission. Network 101 can include various types, such as Wi-Fi, Bluetooth, cellular networks (e.g., 4G, 5G or 6G networks), satellite networks. Network 101 can include technologies for flexible and mobile data exchange, to facilitate data transmissions between EV 105 or remote servers 250 (e.g., in the implementations in which DPS 202 is on a remote server 250, remote from the EV 105). Network 101 can facilitate data transmission across a diverse range of devices and locations, such as via wireless local area networks (WLANs) or Internet.

Videos 204 can include any digital multimedia package (e.g., a container) that can include audio and visual content. Videos 204 can include any type and form of digital multimedia file or content, including recorded or streamed visual and auditory representations of events or scenes. Videos 204 can include recordings in any formats, such as Audio Video Interleave (AVI), MPEG-4 Part 14 (MP4), Matroska Video (MKV) or any other format or type. Videos 204 can include video fragments, having any number of frames. Each frame can include a still image. Videos 204 can include, for example, 30, 45, 60, 90 or 120 frames per second (fps) of video. Videos 204 can include video fragments of a duration of about 3 seconds, such as having 45, 135, 180, 270 or 360 frames per fragment (e.g., for 30, 45, 60, 90 or 120 fps). Videos 204 can include video footage of a drive session from the perspective of a camera 165 located on the front bumper, rear bumper, side door, side mirror, rear-view mirror, dashboard, corner of the EV, roof of the EV or any other portion of EV 105.

Video features 206 can include any features, objects, scenes, locations, persons or things captured by videos 204 during EV 105 drive sessions or trips. Video features 206 can include any recorded elements or features, such as objects (e.g., cars, buildings, bridges, pedestrians, traffic lights, incidents, tools, obstacles, sidewalks, edges of roads, vehicles, motor bikes, accidents or weather conditions). Video features 206 can include scenery or scenes (e.g., city streets, countryside, tourist spots, natural landscapes or locations, sunsets or beaches), locations (e.g., landmarks, cities or monuments), individuals or animals (e.g., pedestrians on streets, or animals in the natural habitat), and various visual and auditory cues (e.g., background woods, mountains, rivers or seas). Video features 206 can indicate or provide a representation or information on the surroundings and events during the drive sessions, providing a detailed visual account of a trip.

Scene model 216 can include any ML or AI model trained on extensive image or video data for detecting or identifying scenes or scene types (e.g., 332). Scene model 216 can be trained using numerous video features data 218, video frames 410 of various video fragments 304, as well as different scenes data 220 of various videos and images. Scene model 216 can be trained to recognize, identify, detect or classify specific scenes from frames of video fragments 304. Scene model 216 can be trained to determine, detect, identify or classify types of scenes 332 based on a portion of a video (e.g., video fragment 304) received as input into the scene model 216. Scene model 216 can include or utilize deep learning techniques, such as Convolutional Neural Networks (CNNs) for feature extraction and classification, and Recurrent Neural Networks (RNNs) for scene or video feature recognition, detection or understanding.

Scene model 216 can be trained on a large dataset that can include features data 218 or scene data 220 of any kind. Features data 218 can include any images or video recordings of features, such as vehicles, buildings, bridges, street signs, pedestrians, traffic lights, machines, incidents or accidents, houses or buildings, trees or rocks, animals or people, or any weather conditions. Scene data 220 can include any images or videos of sceneries, such as beaches, rivers, mountains, parks, woods, mountains, hills, meadows, parks or landmarks. Based on the frames of videos (e.g., frames 410 of video fragments 304) input into the scene model 216, the scene model 216 can identify or detect features, objects, or locations. For example, scene model 216 can identify roads, mountains, woods, beaches, locations, tourist attractions, urban or rural landscapes, camping grounds, lakeside areas or any other scenery. Scene model 216 can utilize any object detection functionalities, such as You Only Look Once (YOLO), image classification models like VGG16, or scene recognition models based on Long Short-Term Memory (LSTM) networks.

Content model 210 can include any ML or AI model trained for content generation and insertion of content in videos. Content model 210 can generate, select, identify, determine or detect any content 212, such as characters or events that can be inserted or processed into the videos 204. Content 212 can include, for example, an animation of vehicles in a car chase, a simulation of an animal movement (e.g., dinosaur chase), simulation or animation of fire, explosions, volcanoes, floods or other events or adventures. Content model 210 can be configured or trained to analyze video segments received as input and determine the most suitable content 212 or type of content 212 to be added, based on the identified features and scenes within the input video 204. Content model 210 can include Content model 210 can utilize techniques such as Generative Adversarial Networks (GANs) and deep learning to identify, select, generate and/or insert content seamlessly into the videos 204. Content model 210 can select or generate content 212 based on the surrounding features or scenes within the video 204. For instance, content model 210 can generate or select virtual characters into real-world road trip footage or introduce augmented reality events in the context of a cityscape (e.g., car chase in city streets). Content model 210 can include or use deep learning models with image generation capabilities to create images from textual descriptions, extending to applications like video content enhancement and virtual reality simulations.

Each of the scene model 216 or content model 210 can include, incorporate or utilize one or more Similarity and Pareto search functions, Bayesian optimization functions, neural network-based functions or any other optimization functions or approaches. Models 216 or 210 can include an artificial neural network (ANN) functions or models, including any mathematical model composed of several interconnected processing neurons as units. The neurons and their connections can be trained with data, such as any input data discussed herein. The neurons and their connections can represent the relations between inputs and outputs. Inputs and outputs can be represented with or without the knowledge of the exact information of the system model. For example, models 210 or 216 can be trained by a model trainer using neuron by neuron (NBN) algorithm.

Content processor 208 can include any combination of hardware and software for processing, inserting or including content 212 (e.g., AR or VR content) into videos 204. For example, content processor 208 can include the functionality or features for incorporating or inserting an animation or simulation into videos 204. Content processor 208 can include the functionality to generate or create the content (e.g., animation or simulation) for inclusion into the video files. Content processor 208 can include functionalities for implementing an overlay of content or incorporating content 212, such as, for example, by using frame-by-frame alignment, scaling of content 212, and rendering of content 212 with the video 204 or composite video 372, to seamlessly blend the AI model generated contents 212 into videos 204 or composite videos 372.

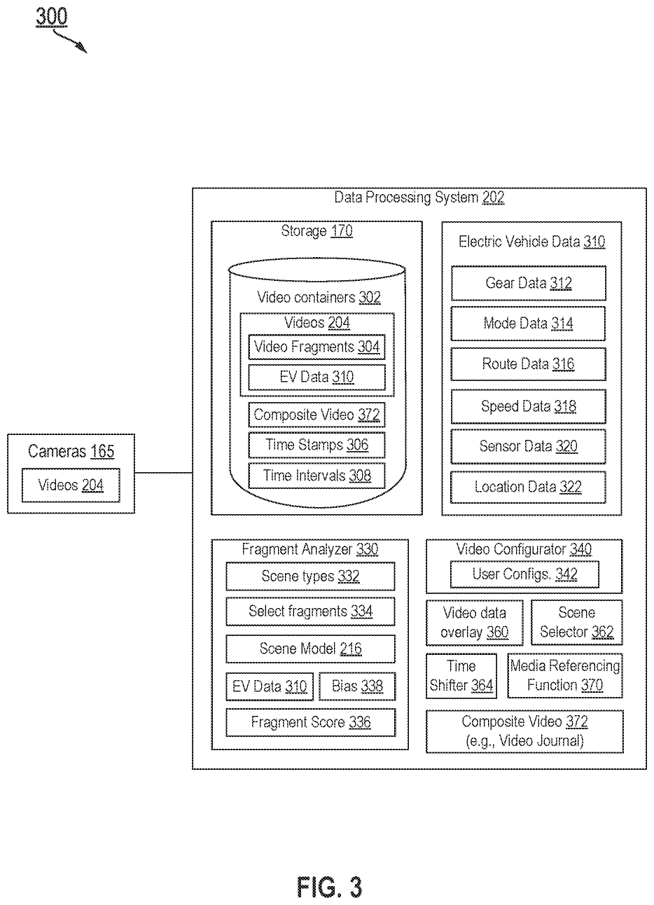

FIG. 3 illustrates a block diagram of an example system 300 that uses AI modeling and EV data of a trip to select video fragments to use in generating a composite video of a drive session. System 300 can include one or more cameras 165 on EV 105 generating and providing videos 204 to DPS 202. DPS 202 can include one or more storages 170, electric vehicle (EV) data 310, fragment analyzers 330, video configurators 340, video data overlays 360, scene selectors 362, time shifters 364, media referencing functions 370 and composite videos 372. Storage device 170, also referred to as storage 170, can include one or more vehicle data 310 and video containers 302. Video container 302 can include one or more composite videos 372 and videos 204 from cameras 165. Video 204 can include one or more video fragments 304 and their corresponding EV data 310. Video container 302 can include one or more time stamps 306 and time intervals 308 corresponding to each videos 204, video fragments 304 and/or composite videos 372. Video configurator 340 can include one or more user configurations 342. EV data 310 can include gear data 312, mode data 314, route data 316, speed data 318, sensor data 320 and location data 322. Fragment analyzer 330 can include one or more EV data 310, biases 338 and scene models 216 determining scene types 332 from the video fragments 304 to select from the video fragments 304 a select fragments 334 for the select time interval 308 according to their fragment scores 336.

For example, system 300 can use AI modeling and vehicle data 310 of a trip to select from video fragments 304 of all videos 204, a group of select fragments 334 to include in a composite video 372 of a drive session (e.g., trip). Fragment analyzer 330 can utilize a scene model 216 to determine or identify scene types 332 of the video fragments 304 of a given time interval 308. Using determined scene types 332, EV data 310 corresponding (e.g., in time) to the respective videos fragments 304 along with any biases 338 that can be applied to one or more video fragments 304 to discourage excessive switching across the scenes, fragment analyzer 330 can determine fragment scores 336 for each of the video fragments 304. Based on the highest fragment score 336 among the set of video fragments 304 corresponding to the same time interval 308, fragment analyzer 330 can choose or identify the select fragment 334 of the given time interval 308 to include into the composite video 372. In doing so, the data processing system 202 of example system 300 can create a composite video 372 using only those video fragments 304 that provide most suitable or desirable scenes (e.g., scene types 332) in the context of the EV data for the time intervals 308 of those video fragments 304 and as adjusted by the bias 338.

Composite video 372 can be generated using select fragments 334 for one or more (e.g., some or all) of time intervals 308 between the initial time stamp 306 and the final time stamp 306 for each of the videos 204. As each of the cameras 165 can generate a single continuous video 204 file covering the entire time duration of the trip (e.g., between the initial and final time stamps 306 of the drive session), composite video 372 can be compiled from the select fragments 334 for each, or subset of, the time intervals 308 within the videos 204, taking most suitable video fragments 304 from each of the cameras 165. Composite video 372 can be limited in time duration, based on user configurations 342 or thresholds that can be applied to remove video fragments 304 whose fragment scores 336 or EV data 310 are below their respective thresholds.

Each video fragment 304 can correspond to a time interval 308 (e.g., 3 seconds of video) and can include metadata (e.g., fragment metadata 408) that can include or indicate any values, measurements or parameters of EV data 310. EV data 310 indicated in the fragment metadata 408 of the video fragments 304 can include parameters or values corresponding to EV 105 operation during the time interval 308 corresponding to the video fragment 304 (e.g., 3 seconds of the video fragment). EV data 310 can include, for example, operating gear data 312, operating mode data 314, route data 316 of the route on which the EV 105 is riding, speed data 318 on the speed of the EV 105, sensor data 320 on sensor readings (e.g., temperature, pressure, vibrations, acceleration, momentum, impact), or location data 322 on the location of the EV 105. Fragment analyzer 330 can identify select fragments 334 from all video fragments 304 of all videos 204 using scene model 216 identifying the scene types 332, as well as EV data 310 and bias 338. Fragment analyzer 330 can determine the fragment scores 336 using user configurations 342 from video configurator 340 to provide preference to certain scenes types 332 or to set a minimum acceptable fragment score 336 based on the composite video 372 duration set by the user. Scene selector 362 can select the select fragments 334 along with media referencing function 370. Composite video 372 can be edited or modified using time shifter 364 implementing temporal offsets and scaling and using a data overlay 360 to overlay content on the composite video 372.

Video containers 302 can include any digital file format encapsulating multimedia (e.g., video file), including its images or frames, audio tracks, subtitles and metadata. Video container 302 can any file format that can be used to encapsulate multimedia data, such as image, video or audio data. Video containers 302 can be used for videos 204, composite videos 372, video fragments 304 or select fragments 334. Video containers 302 can correspond to each individual video or video fragment or to entire video. Video containers 302 can serve as a wrapper for videos 204 or video fragments 304, including its metadata, such as EV data 310, time stamps 306, time intervals 308 or any other information that can be indicated or included in the meta data of a video 204, video fragment 304 or composite video 372. Video container 302 can be used for any video file format, such as MP4 or AVI, and can encapsulate the entire video content, including both video and audio tracks, and often include information about codecs and subtitles or content to be inserted.

Video fragments 304 can include any portion or a segment of a video 204. Video fragment 304 can include a self-contained segment of video 204 and can be configured for adaptive streaming or to improve efficient content delivery. Video fragments 304 can be encapsulated with their own metadata and ancillary features in a container, such as a fragmented MP4 (fMP4) or MPEG-DASH. Video fragments can include frames (e.g., 30, 45, 60, 90 or 120 frames per second) and can include any number of frames for a set duration of the video fragment 304. For example, video fragment 304 can be 1, 2, 3, 5, 10 or 15 seconds long and can include compact segments of videos 204. Video fragments 304 can be combined into a single container, allowing for the synchronization of different multimedia sources to create a composite video 372.

Time stamps 306 can include any references or indicators of time or chronology in a video file (e.g., video 204, video fragment 304 or composite video 372). Time stamps 306 can include metadata or indications of date (e.g., month, day and year), time of day (e.g., hour, minutes and seconds) of any particular video file. Time intervals 308 can include any time duration of a video file (e.g., video 204, video fragment 304 or composite video 372). Time duration 308 can include days, hours, or minutes of a continuous video file. Time stamps 306 for videos 204 and video fragments 304 can include any temporal markers that denote the beginning and conclusion of video file. Time stamps 306 can define specific time intervals 308 within video files, such as time intervals of video fragments 304 (e.g., 3, 4 or 5 seconds).

EV data 310 can include any data of EV 105. EV data 310 can include measurements, data, values or parameters corresponding to, or indicative of, operation, performance or status of EV 105. EV data 310 can include or provide contextual information about the EV 105, including, for example the gear of the EV 105 (e.g., park, neutral, reverse or drive), speed, acceleration or GPS coordinates of EV 105, drive mode (e.g., sand, snow, off-road, sport), providing context of, or related to, video segments 304 captured at those time intervals 308. EV data 310 can be inserted as metadata to videos 204 and/or video fragments 304. EV data 310 can include and be used to determine, infer or establish the context of the operation and surroundings of the EV 105 during various moments or points of a recorded drive session (e.g., off-roading adventure or a family trip).

EV data 310 can include gear data 312, which can include any information on the state or status of the gear of the EV 105 engaged at a given moment, such as drive mode, parked mode, or reverse mode. EV data 310 can include mode data 314, which can include an operational mode of the EV 105, such as “eco” mode for enhanced energy efficiency or “sport” mode for heightened performance. EV data 310 can include route data 316, which can include information about (e.g., identifying or describing) a specific road or path traveled by EV 105, such as a highway, state road, off-roading path, mountain terrain, or urban street. EV data 310 can include speed data 318, which can include or identify the vehicle's velocity, such as 60 miles per hour. EV data 310 can include sensor data 320, which can include or indicate sensor readings or data from various EV 105 sensors. Sensors providing sensor data 320 can include any devices, detectors or sensors measuring any one or combination of: battery state of charge (SOC), temperature, pressure, velocity, acceleration, brake position, throttle position, proximity or object presence or distance, current, power or energy (e.g., power consumed). EV data 310 can include sensor measurements corresponding to jerk intensity, G-force, acceleration or deceleration, vibration, pressure or tension, or any other sensor measurement. EV data 310 can include a location data 322, which can include an EV 105 location identifying, for example, the geographic coordinates (e.g., latitude and longitude of the EV) at which a video fragment 304 was recorded.

Scene types 332 can include any type of scene from video fragments 304. Scene types 332 can be provided by scene model 216, also referred to as the scene analyzer. Scene type 332 can include a view or environment of any specific video frame or video fragment 304. Scene types 332 can include a wide range of visual environments and scenarios, reflecting the diversity of driving experiences. For example, scene type 332 can include a city scene (e.g., environment of a downtown of a large city with dense vehicle traffic and lots of pedestrians), a suburban scene (e.g., a suburban town with residential houses and yards), a village scene (e.g., a view of a small village), a road scene (e.g., a scenery of a highway, country road or city street), a mountain view (e.g., view of mountains or hills), a beach scene (e.g., sand or rock beach with a sea or ocean), a river scene, tunnel scene, bridge scene, a woods scene or any other type of scene or scenery.

Fragment analyzer 330 can include any combination of hardware and software for analyzing and scoring video fragments 304. Fragment analyzer 330 can utilize scene model 216 to determine scene types 332 of the video fragments 304. Based on EV data 310, scene types 332 for each video fragment 304 and the bias 338 (e.g., for providing preference to video fragments 304 that come from the same camera 165 as the preceding select fragment 334), fragment analyzer 330 can determine or identify a fragment score 336 for each video fragment 304 of that time interval 308. Based on the fragment score 336, fragment analyzer 330 can determine the next select fragment 334 to include in the composite video 372 to be compiled.

For instance, a fragment analyzer 330 can identify or select a video fragment 304 from each of a plurality of cameras 165 of the EV 105 for a given time interval 308 between the initial time stamp 306 and a final time stamp 308. By processing each of the video fragments 304 for the given time interval 308, fragment analyzer 330 can determine the scene type 332 using the scene model 216. Fragment analyzer 330 can determine and utilize the EV data 310 (e.g., EV data 312-322) for the same video fragments 304, which can be stored in the video fragment metadata 408. Fragment analyzer 330 can apply a bias 338 to add a preference or improve the score of the video fragment 304 from the same camera 165 as the select fragment 334 for the preceding time interval 308. In doing so, fragment analyzer 330 biases the composite video 372 to avoid shifting between scenes every 3 seconds, but rather staying with a scene for multiple time intervals 308, until a more meaningful scene develops at a different camera 165. Fragment analyzer 330 can determine the fragment score 336 (e.g., score between 1-10, or 0-100) for each of the video fragments 304. Fragment score 336 can include any value or parameter denoting preference, importance or value of a particular video fragment 304 with respect to other video fragments 304 within a same time interval 308.

Fragment analyzer 330 can include a minimal score threshold below which select fragment 334 will not be selected for a given time interval 308. For example, if each of the fragment scores 336 for a given time interval 308 fall below the minimal score threshold, fragment analyzer 330 can determine that the given time interval does not include any sufficiently meaningful events or scenes during that time interval 308 to include in the composite video 372. Finally, select fragments 334 for all time intervals 308 between the initial and final time stamps 306 (e.g., that exceed the minimal fragment score) can be included in the composite video 372.

Bias 338 can include any value or a parameter for adjusting (e.g., increasing) the likelihood that the current select fragment 334 comes from the same camera 165 as the prior select fragment 334. For example, bias 338 can include an offset or adjustment to a fragment score 336 of the video fragment 304 from the same camera 165 as the prior select fragment 334 (e.g., select fragment 334 for the preceding time interval 308). Bias 338 can include a function that can include an exponential component, whereby a first offset to the score of a first video fragment 304 from the same camera 165 as the select fragment 334 immediately preceding the first video fragment 304 is larger than a second offset to the score of a second video fragment 304 from the same camera 165 following the first video fragment. Bias 338 can therefore decrease the offsets or adjustments to the video fragments 304 of the same camera 165 for each successive time interval 308. In doing so, the bias 338 reduces the chance that scene changes very quickly after a change of the view to a camera 165, but as time intervals 308 pass, the bias 338 is reduced to make it more likely for a change to occur (e.g., due to change in fragment score 336).

Fragment analyzer 330 can include or utilize a scene selector 362 for selecting a scene or a video fragment 304 using a cost function. The cost function can be represented as: C(t)=Ws.Cs(t)+Wv.Cv(t)+Wp.Cp(t), where W's represent weighted parameters for any of the components, s corresponds to a scene model 216 output (e.g., scene type determined by scene analysis), v corresponds to EV data 310 (e.g., contextual data of the EV 105 at the time of the video segment 304 of the scene and p corresponds to persistent bias 338 to reduce frequent scene changes by introducing a decay function at the beginning of the scene. Decay function, having, for example, Cp(t)=e\hat{ }(−b (fps, Vspeed)t), where b corresponds to an adjustable or set constant parameter in the exponent for scaling the fps (frames per second) and Vspeed (e.g., EV speed or other EV data 310) as a function of time.

Video configurator 340 can include any combination of hardware and software for configuring or providing preferences for selecting select fragments 334. Video configurator 340 can include or use a user interface for users to input user configurations 342 for creating customized video content. User configurations 342 can identify, list or specify user's desired scene types 332, duration of the composite videos 372, durations of scenes spanning multiple select fragments 334 from the same camera 165, or any other preference of the user. Fragment analyzer 330 can use the user configurations 342 to make or adjust the determination or scoring for select fragments 334.

Video data overlay 360 can include any combination of hardware and software for overlaying data or content over the composite video 372. Video data overlay 360 can include the functionality for overlaying or displaying (e.g., over the composite video 372) any EV data 310, such as speedometer output, speed charted over time, elevation, torque per motor, motor temperature, battery information, G-force (e.g., strength and direction), route of a trip, suspension and drive mode data, location data of maps or topology, and branding or logos of an organization or establishment. Video data overlay 360 can be used to display any feature of the composite video 372, including camera 165 that is the source of each select fragment 334, scene types 332 or any other features or parameters.

Time shifter 364 can include any combination of hardware and software for offsetting or shifting timing of composite video 372 scenes. For instance, as some stretches of composite video 372 may be uneventful to watch in real time speed, timing of such sections of composite video 372 can be sped up (e.g., by displaying every 2^{nd}, 3^{rd}, 4^{th}, 5^{th}, 10^{th}, 15^{th} frame in the select fragment 334, thereby speeding up the scenes in such portions of the composite video 372. Time shifter 364 can include automated time lapse portion of content to speed up some sections of the video. Time shifter 364 can also slow down some sections of the video, providing slow motion view of some events. Time shifter 364 can cut between cameras or show over contextual data about the location or vehicle status.

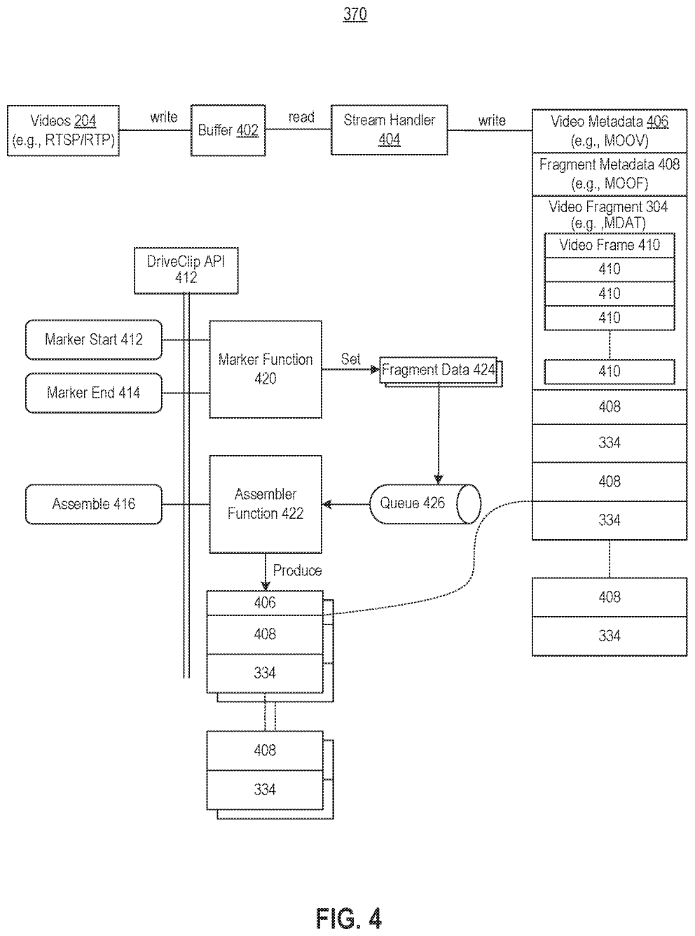

FIG. 4 illustrates a block diagram of an example media referencing function 370 that can be used by technical solutions, such as in example systems 200 or 300. Media referencing function 370 can include any combination of hardware and software for managing storage and access to video data (e.g., videos 204, video fragments 304 or composite videos 372). Media referencing function 370 can be a part of a video management system to control, manage or optimize storage, efficiency of storage and content creation. Media referencing function 370 can utilize fragment MP4 for dashboard camera that may continuously record content, generate or process video fragments 304 and save them to storage 170. Media referencing function 370 can include functionalities for reducing content redundancy. For instance, media referencing function 370 can refer to certain video fragments 304 using storage pointers or uniform resource identifiers (URIs) to existing video scenes (e.g., one or more video fragments 304) rather than storing a second copy of the same video scene.

Media referencing function 370 can include a buffer 402 for receiving video files (e.g., videos 204 or video segments 304). Buffer 402 can receive videos via a real-time streaming protocol (RTSP) and real-time transport protocol (RTP), which can be utilized together for the transmission of real-time audio and video data over the network 101 (e.g., to allow for efficient video processing or streaming). In some implementations, buffer 402 can receive videos using RTSP or RTP. Stream handler 404 can read the data from the buffer 402 and write, enter or edit video data of the video files.

Stream handler 404 can read from or write to video metadata 406. Video metadata 406 can include any metadata for any video file, such as video 204 or composite video 372. Video metadata 406 can include any data structure for the file format of the video files (e.g., videos 204 or composite videos 372). For example, video metadata 406 can include a movie box (MOOV) data structure in MP4 file format for storing video files.

Stream handler 404 can read from or write to fragment metadata 408. Fragment metadata 408 can include any metadata for video fragments 304. Fragment metadata 408 can include any data structure for the file format of the video fragments 304, such as moof box (MOOF) of the MP4 format for organizing data for the video fragments 304. Fragment metadata 408 can include any information or data for any video fragment 304, such as EV data 310 for the video fragment 304, scene type 332 for the video fragment 304, or any scores for the video fragment 304.

Videos 204 or composite videos 372 can include a video metadata 406 comprising information or data (e.g., metadata) about the entire video 204 or composite video 372. Within the video file (e.g., 204 or 372) there can be a plurality of fragment metadata 408 preceding video fragments 304 and including metadata (e.g., fragment scores 336, EV data 310, scene type 332, source camera 165) or any other information corresponding to the video fragment 304. Within video fragments 304, a plurality of video frames 410 and other data (e.g., audio or similar) can be provided. Each of the video fragments 304 can be preceded in the video file by a fragment metadata 408.

Media referencing function 370 can include application programming interface (API) which can make calls to various functions. Media referencing function 370 can include a DriveClip API 412 and the Assemble API 416 to manage video fragments within a larger video recording system. DriveClip API 412 can utilize a marker start 412 and the marker end 414 to call on the marker function 420 to set fragment data 424 (e.g., fragment metadata 408 with video fragment 304). Assemble 416 can provide or include an API call to assembler function 422 to assemble the fragment data 424 into the produced video file (e.g., composite video 372).

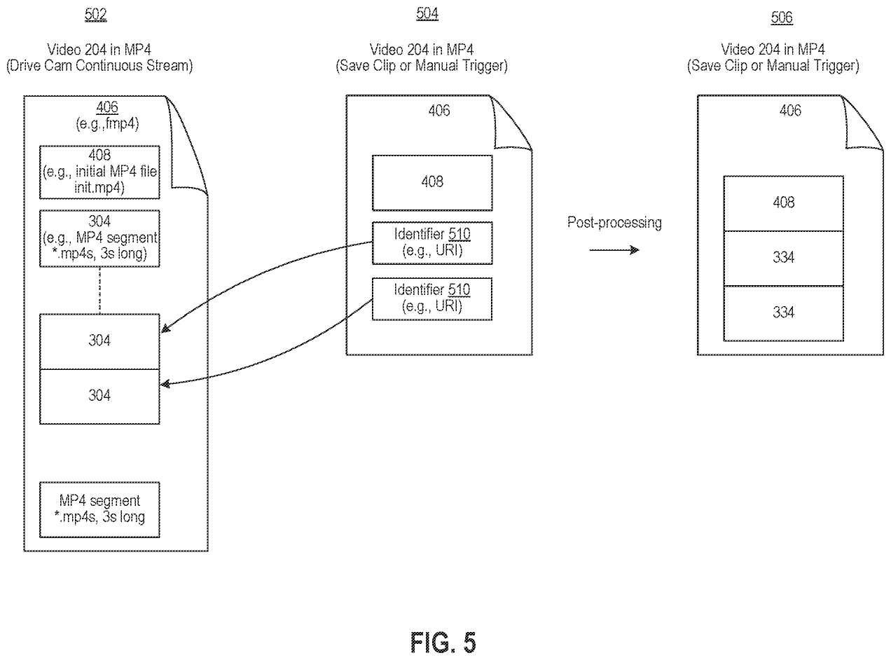

FIG. 5 illustrates block diagram examples 502, 504 and 506 of video formatting and organization that can be utilized by the technical solutions. FIG. 5 illustrates an example 502 of a video 204 and video fragments 304 as provided by a camera 165 generating a continuous stream of a trip; example 504 of a video 204 and video fragments 304 processed with a save clip or manual trigger; and example 506 of video 204 and video fragments 304 during post processing (e.g., during compilation of composite video 372).

At example 502, video 204 of MP4 format can include a video metadata 406 (e.g., fmp4) for the video 204. Following the video metadata 406, video 204 can include a series or a chain of pairs of fragment data 424. Each fragment data 424 in the chain or series can include a fragment metadata 408 followed by video fragment 304. At example 504, video 204 of MP4 format can include a video metadata 406 and video fragment metadata 408, followed by identifiers 510 (e.g., uniform resource locators or URIs) to video fragments 304. Identifier 510 can include any unique identifier of a video fragment 304, such as a URI, a link, a memory location address, a variable name or any other combination of numbers or characters uniquely identifying a video fragment 304. By utilizing save clip or manual trigger, technical solutions can avoid storing the same data multiple times. At 506, video 204 can include a video metadata 406 that can be followed by fragment metadata 408 and then by select segments 334, which may or may not be indicated by identifiers 510.

Stream handler 404 can read from or write to video fragments 304, including their video frames 410. Video fragment 304 can include Media Data file format (MDAT), which can include audio and video media data, including any encoded video or audio frames or samples. Video frames 410 can include frames of each of the video fragments 304. Each video frame 410 can include a still image of the video fragment 304. Video fragment 304 can include any number of video frames 410, such as 15, 30, 45, 60, 90 or 120 frames per second (fps).

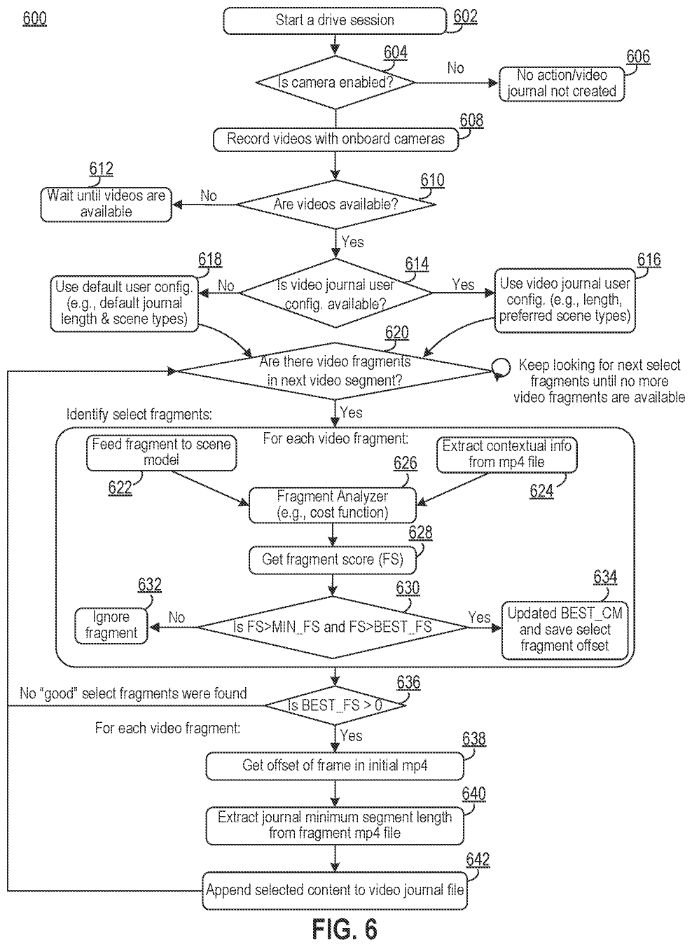

FIG. 6 illustrates a flow diagram of an example method 600 of generating a composite video of a drive session using AI modeling, EV data, fragment bias and user preferences to select video fragments for the composite video. Method 700 can include ACTSs 602-642. ACTs 602-642 can be performed by any features or functionalities of systems 200 or 300 or any components discussed herein.

At 602, an EV can start a drive session, such as for example an off-roading trip, a family trip, or a drive to any particular location. At 604, EV can determine if camera is enabled. For instance, upon starting the EV, a data processing system can send signals to check if the cameras deployed, installed or distributed at various parts of the EV are turned on and configured for recording. Data processing system can receive a response indicating that one or more cameras are ready for use or indicating that one or more cameras are not. At 606, if none of the cameras are enabled or ready for use, EV may take no action and no video journal (e.g., composite video) may be created for this trip. In some examples, a user can be prompted via an infotainment system if the user wants to create a video journal. In response to the user response to the prompt, the data processing system can configure the cameras and start recording.

At ACT 608, EV can record videos with onboard cameras. Cameras deployed around the EV (e.g., at the dashboard, windshield or rear window, side windows or side doors, front or rear bumpers, side mirrors or any other location at the EV) can each be directed to different directions and covering a different field of view. Each of the cameras can record a continuous video from an initial time stamp (e.g., start point at the start of the drive) to a final time stamp (e.g., at the end of the drive). For example, if an EV includes 5 cameras, the each of the 5 cameras can record the drive session from its own viewpoint from the beginning to the end of the trip.

At 610, a determination can be made if videos are available. For example, data processing system can check if videos are available for processing. For example, the videos from the plurality of cameras of the EV can each be available for processing in response to the EV completing its trip (e.g., after the final time stamp on each of the videos). At 612, if videos are not available, data processing system can wait until videos become available (e.g., upon completion of the drive session).

At 614, data processing system can determine if video journal user configuration is available. For example, a user can use a video configurator to provide user preferences for configuring the video journals (e.g., composite videos) to be generated by the data processing system. User configurations can include, for example, one or more preferred scenes or scene types to look for, a preferred length of the entire composite video, a preferred minimum bias for a current video camera view (e.g., duration of time before a switch to another camera view is considered) so as to limit frequent switching between cameras. At 616, if the video journal user configuration is available, data processing system can use the video journal user configuration. If the user configuration is not available, at 618 the data processing system can use default configurations or settings of the data processing system (e.g., default length of the composite video or a default bias function).

At 620, data processing system can determine if there are video fragments in the next video segment. The next video segment can correspond to a following time interval of the videos. For example, each of the videos recording the drive session can have their recording start at the initial time stamp at the start of the drive and end at the final time stamp at the end of the drive. Each of the videos can include a plurality (e.g., a chain or a series) of video fragments corresponding to a chain or a series of time intervals (e.g., time durations of 3 seconds) between the initial and final time stamp of each of the videos. Data processing system can determine if within the next time interval for the videos there are any video fragments that can be considered for inclusion into the video journal of the trip. Data processing system can keep looking for the next fragments to select until no more video fragments are available (e.g., until all the video fragments for all time intervals are considered).

ACTS 622-634 can be implemented to identify select video fragments to use in the composite video (e.g., journal video of the trip) from all the video fragments of all the cameras for the given time interval. At 622, video fragments can be input into a scene model. The video fragments input into the model can be video fragments of the same time interval (e.g., duration of 3 seconds) from all the active cameras capturing videos. The scene model can include AI or ML functionality to identify, detect or determine a type of a scene (e.g., scene type) in the video fragment using detected the features, objects or other content in the video fragment and/or its video frames.

At 624, contextual data corresponding to the video fragment (e.g., EV data in the metadata of the video fragment) can be extracted for the fragment analyzer. For example, EV data (e.g., gear data, drive mode data, routed data, speed data, sensor data, location data or any other data of the EV) that was input or inserted into the metadata of the video fragments during storage of the video fragments, can now be retrieved for processing by the fragment analyzer.

At 626, fragment analyzer can utilize its cost function to determine a fragment score of the video fragments. For example, fragment analyzer can use any combination of any number of: one or more scene types determined by the AI or ML scene model from the video fragment, one or more EV data corresponding to the time interval of the video fragment and one or more biases applied for one or more video fragments. Fragment analyzer can offset the evaluation or determination of the fragment score based on user preferences. At 628, fragment analyzer can determine the fragment score, at 628, for the given video fragment.

At 630, fragment analyzer or scene selector can determine or compare the fragment score of the current video fragment against scores of other fragments in the same time interval. If the fragment score of the current video fragment is greater than the minimum threshold for the fragment score and if it is also greater than the currently best (e.g., highest) fragment score of any other fragment in the time interval, then at 634 data processing system can update the best fragment score and use the current fragment as the select fragment for the composite video. If however, at 632, fragment score is either not greater than the minimum threshold score or if not greater than the current best (e.g., highest) fragment score, then the video fragment is ignored.

At 636, data processing system determines if the best fragment score is greater than zero. For example, if none of the fragment scores are above a minimum score threshold level, then none of the video fragments of the time interval are determined to be sufficiently eventful, informative, interesting or relevant to be included in the video journal, and the method 600 can go back to ACT 620. If however at 636, the best or highest fragment score is greater than zero, then at 638 the offset of frame in initial container (e.g., MP4) of the video is identified. For instance, once a video fragment has scored sufficiently to be included in the composite video, in order the find the selected fragment (e.g., its starting frame) within the video MP4 file, data processing system can locate the offset of the video fragment or video frame within the corresponding initial MP4 file and move to the correct offset in the fragment mp4 file.

At 640, the data processing system can extract the journal minimum segment length from the fragment mp4 file. For example, data processing system can utilize media referencing function to identify the video frames in the video of the camera that correspond to the video fragment identified as the select fragment. The video fragment can be extracted in accordance with the minimum segment length, which can correspond to the time interval (e.g., anywhere between 1 and 30 seconds, such as 3 seconds for example). At 642, identified or captured select video fragment can be inserted, added, appended or otherwise incorporated into the composite video (e.g., video journal).

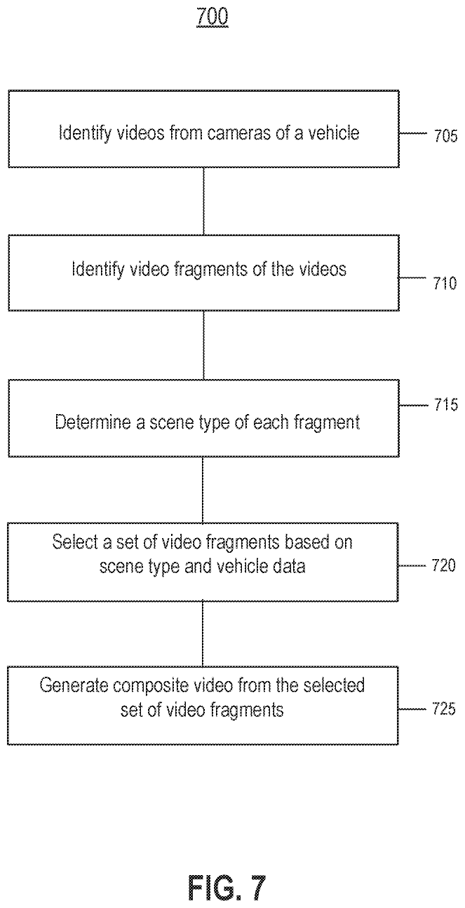

FIG. 7 is a flow diagram illustrating an example method 700 of generating a composite video of a drive session using at least AI modeling and EV data for selection of video fragments. Method 700 can be implemented using example systems 200 or 300 and any other features discussed in connection with figures herein. Method 700 can include ACTS 705-725. At 705, the method can identify the videos from cameras of a vehicle. At 710, the method can identify video fragments of the videos. At 715, the method can determine a scene type of each fragment. At 720, the method can select a set of video fragments based on scene type and vehicle data. At 725, the method can generate a composite video from the selected set of video fragments.

At 705, the method can identify the videos from cameras of a vehicle. The method can include one or more processors coupled with memory identifying a plurality of videos taken from a vehicle. Each video of the plurality of videos can be captured between a first time that can be marked by a time stamp at the start of the video and a second time that can be marked by a second time stamp at the end of the video. For example, each video of the plurality of videos can be captured by a camera of a plurality of cameras of the vehicle. Each of the plurality of cameras can be turned to a direction different from a direction of each other of the plurality of cameras. For example, each of the cameras can capture an entire drive from beginning to end and therefore cover the same time period as each other camera of the plurality of cameras, from its own point of view.

Data processing system can use one or more functions to process videos from each of the cameras. Each of the videos can be captured in a file format having one or more containers for organizing the video files of each of the cameras into video fragments. Data processing system can use one or more processors to determine that a drive session is complete. Data processing system can use the one or more processors to identify responsive to the determination that the drive session is complete, the plurality of videos of the drive session captured by a plurality of cameras of the vehicle.

At 710, the method can identify video fragments of the videos. The method can include the one or more processors of the data processing system identifying for the plurality of videos, a plurality of video fragments. Each video fragment of the plurality of video fragments can correspond to data of the vehicle at a time interval of a plurality of time intervals between the first time and the second time for each video of the plurality of videos. For example, a set of cameras of the electric vehicle capturing a drive session can each include its own video fragment corresponding to a time interval. Time interval can include a series of video frames for a duration corresponding to a portion of a video, such as a duration of 1 second, 2 seconds, 3 seconds, 4 seconds, 5 seconds, 7 seconds, 10 seconds, 15 seconds, 30 seconds or more than 30 seconds.

Video fragments can be identified based on identifiers uniquely identifying a video fragment within a video file captured by a camera. Video fragments can be identified based on a fragment metadata preceding the video file or following the video file. Each of the video fragments can have their own metadata comprising data of electric vehicle captured during the time of the capturing of the video fragment. Data of electric vehicle can include any EV data, such as gear data, mode data, route data, speed data, sensor data or location data.

At 715, the method can determine a scene type of each fragment. The method can include the one or more processors of the data processing system determining, based on the plurality of video fragments input into a model trained on a data of a plurality of scenes, a type of scene for each video fragment of the plurality of video fragments. For example, each video fragment of a group of video fragments corresponding to a same time interval (e.g., time period of 3 seconds) can be input into a scene model. The scene model can be an AI or ML model that can be trained using multimedia data (e.g., videos or images) of various scenes or scenery captured by various cameras. The scene model can be configured to identify, detect and indicate the type of scene in the video fragment input into the scene model.

The scene model can determine that a video fragment of a first camera captures a first scene (e.g., a mountain, a forest, a river or a natural habitat) and can give that scene a particular (e.g., a high) priority level (e.g., confidence measure). The scene model can determine that a video fragment of a first camera captures an empty road or highway and can give that scene a particular (e.g., lower) priority level (e.g., low confidence score). The confidence measures can be based on a ranking or preferences of the user. The preferences can be provided by the user in user configurations or can be established by the data processing system based on, for example, user preferences monitored or accumulated over time. Confidence measure can reflect types of scenes or events that are preferred in the composite videos.

At 720, the method can select a set of video fragments based on scene type and vehicle data. The method can include the one or more processors of the data processing system selecting a set of video fragments based on the respective data and the respective type of scene of a plurality of sets of video fragments. The data of the vehicle can include any data EV data, such as gear data, mode data, route data, speed data, sensor data, location data or data of any other measurement, sensor reading or determination corresponding to EV during the time of the video fragment. The data can be indicated in the metadata of the video fragment and by the fragment analyzer to determine the score for the video fragment.

The method can include the one or more processors generating a score for each video fragment of each set of video fragments of the plurality of sets of video fragments. The score can be determined by the fragment analyzer according to the data of the EV and the type of scene of the respective video fragment. The score for a video segment of a group of video segments corresponding to the same time interval can be determined based at least on the bias for the video segment, the data of the EV for the video segment and the priority level (e.g., confidence measure) of the type of scene determined by the AI or ML scene model.

The method can include the one or more processors of the data processing system selecting for each respective set of video fragments, a selected video fragment of the respective set according to the score of the selected video fragment. The method can include the one or more processors of the data processing system selecting the set of video fragments for a plurality of sets of video fragments corresponding to at least a subset of the plurality of time intervals. Each selected video fragment of the selected set of video fragments corresponding to a time interval of the subset of the plurality of time intervals.

Each of the plurality of sets of video fragments can include includes a plurality of video fragments from the plurality of videos captured by a plurality of cameras. Each of the plurality of sets of video fragments can correspond to a different time interval of the plurality of time intervals between the first time (e.g., at the start of the recorded drive session) and the second time (e.g., at the end of the recorded time session).

At 725, the method can generate a composite video from the selected set of video fragments. The one or more processors of the data processing system can generate a composite video using the set of video fragments. The one or more processors can generate the composite video using the set of video fragments corresponding to the at least a subset of the plurality of time intervals. The one or more processors can generate the composite video corresponding to the subset of the plurality of time intervals using the set of video fragments.

The method can include the one or more processors of the data processing system identifying a feature of the composite video. The method can include the one or more processors determining, based at least on the composite video input into a model trained using machine learning on a data comprising a plurality of features in the plurality of scenes, a scene of the composite video corresponding to the feature. The method can include the one or more processors of the data processing system selecting, based on the scene, content to insert into the composite video. The method can include the one or more processors of the data processing system providing, for display, the composite video including the content.

The method can include the one or more processors identifying data of the vehicle corresponding to a fragment of the composite video and selecting, based on the data and the scene, the content to insert into the composite video. The method can include the one or more processors identifying a location of the feature in a frame of the composite video and generating, based at least on the scene input into a second model trained using machine learning on data comprising a plurality of contents, the content to insert into the composite video. The one or more processors can select the content responsive to the generating and insert the content into the frame of the composite video according to the location of the feature.

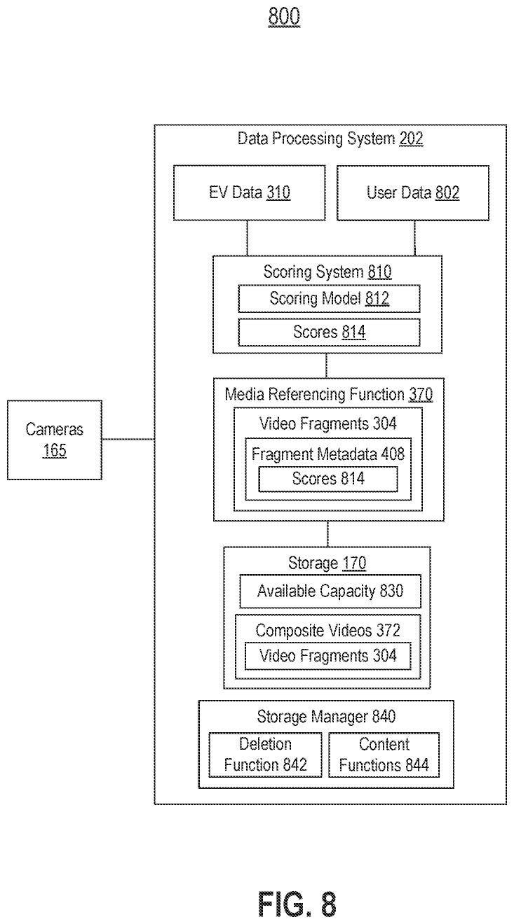

FIG. 8 illustrates a block diagram of an example system 800 for managing a storage device available capacity by protecting from deletion video fragments of higher priority using a scoring system based on data of the vehicle. System 800 can include one or more cameras 165 communicatively coupled with a DPS 202 comprising one or more vehicle data 310, user data 802, scoring systems 810, media referencing functions 370, storages 170 and storage manager 840. Scoring system 810 can include one or more scoring models 812 and scores 814. Media referencing function 370 can include one or more video fragments 304 with fragment metadata 408 including scores 814. Storage device 170 can include available capacity 830 (e.g., unoccupied memory available for storing new data) and one or more composite videos 372 with video fragments 304. Storage manager 840 can include one or more deletion functions 842 and content functions 844.

The technical solutions can leverage EV data 310 (e.g., jerk intensity, acceleration or deceleration, or G-force of the EV 105) along with user data 802 (e.g., user profiles, preferences, instructions) to utilize a scoring model 812 of the scoring system 810 to generate scores 814 (e.g., priority scores) for the video fragments 304. Media referencing function 370 can store each priority score 814 of each of the video fragments 304 in fragment metadata 408 of each of the video fragments 304. Storage manager 840 can utilize deletion function and content functions 844 to manage, control (e.g., delete or edit) video fragments 304 stored in the storage 170. As storage manager 840 deletes some video fragments 304 (e.g., older video fragments stored prior to more than a retention period of, for example, 14 days ago) to delete those video fragments 304 with lower priority scores 814.

Scoring system 810 can include any combination of hardware and software for implementing priority or retention scoring for video fragments 304. Scoring system 810 can include functionality (e.g., models or functions) for determining scores 814 based on which video fragments 304 can be retained or deleted. Scoring model 812 can determine scores 814 which can indicate the priority level of each of the video fragments 304 with respect to their retention or deletion from the storage 170. Scoring model 812 can include any function or a model, such as an AI or ML model, for determining priority or retention scores 814 using the EV data 310 and user data 802.

Priority scores 814 can be determined based on, to coincide with or to provide information for events of importance, such as events in which a jerk intensity or acceleration or deceleration of the vehicle beyond a threshold or a collision detection has occurred. Priority score 814 can correspond to any number which can correspond to the level of importance or retention of the video fragment 304. For instance, scores 814 can be distributed from 1 through 5 in increasing level of priority, or 1 through 10 or 1 through 100 or any other number.

Priority score 814 can be given the lowest level (e.g., score of 1) for video fragments 304 corresponding to time intervals 308 during which no external motion is detected, during which scene is static, or when parking mode is on, or when driver seat is not occupied. Priority score 814 can be given a score of 2 when external motion is detected, a dynamic scene is detected (e.g., change in placement of objects from a prior video frame or fragment), when drive mode is on or driver seat is occupied. Priority score 814 can be given a score of 3 when level 1 of advanced driver assistance systems (ADAS) is activated, or when at least one of the camp mode, sand mode or off-roading mode is turned on. Priority score 814 can be given a score of 4 when a horn is pressed in the EV 105 or when horn is heard from another vehicle, when hazard light is switched on or when ADAS level 2 is activated. Priority score 814 can be given a score of 5 when a collision is detected, jerk intensity beyond a threshold is detected, G-force beyond a threshold is detected or when emergency evasive maneuver is triggered (e.g., trailer sway mitigation is activated).

User data 802 can include any information on user preferences or actions that can be indicative of which video fragments 304 to delete or retain. User data 802 can include user actions, such as user configurations 342 or user preferences, that can be indicative which video fragments 304 at which time intervals 308 can be more important than others. User data 802 can be used to prioritize video fragments 304 with respect to some time intervals 308 over video fragments 304 of other time intervals.

Storage device 170, also referred to as storage 170, can be any device for storing information or data, such as a hard disk drive (HDD), solid state drive (SDD), USB flash drive, memory card, compact disc (CD), digital versatile disk (DVD), network attached storage (NAS), cloud storage or any other device or system for storing data. Storage device 170 can include available capacity 830, which can have any free or available space for storing data on storage 170. Available capacity 830 can include a number of memory locations for storing bits or bites of data in storage 170. Available capacity 830 can be specified using bits, bytes, kilobytes, megabytes, gigabytes or terabytes of data in which additional video fragments 304 can be stored.

Storage manager 840 can include any combination of hardware and software for managing storage (e.g., storing or deletion) of data in storage 170. Storage manager 840 can include deletion function 842 for implementing deletion of data per scores 814. Storage manager 840 can include or implement thresholds for deleting data, such as thresholds determined based on the scores 814. Storage manager 840 can include content functions 844 for implementing changes or edits to the contents (e.g., video fragments 304). Storage manager 840 can determine which video fragments 304 to delete and which to retain based on the scores 814 and the available capacity 830.

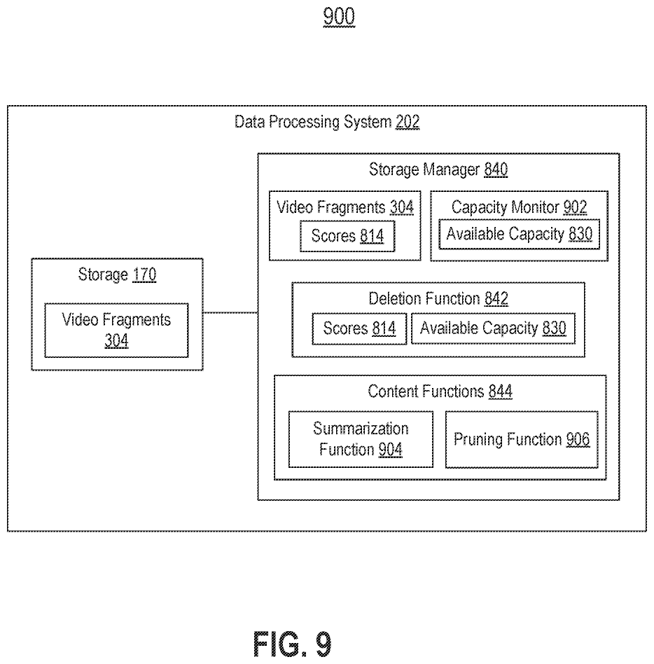

FIG. 9 illustrates a block diagram of an example system 900 for managing the storage on the storage device 170 based on the available capacity 830 and priority scores 814 of the video fragments 304. Example system 900 can include a data processing system 202 having a storage 170 storing video fragments 304 and being communicatively coupled with a storage manager 840. Storage manager 840 can include, monitor or process video fragments 304 with scores 814. Storage manager 840 can include or utilize capacity monitor 902 for monitoring available capacity 830. Storage manager 840 can include a deletion function 842 that monitors, considers or uses scores 814 of various video fragments 304 along with the current amount of available capacity 830 to determine which video fragments to delete and which to retain. Storage manager 840 can include content functions 844 that can include one or more summarization functions 904 and pruning functions 906.

Capacity monitor 902 can include any combination of hardware and software for monitoring available capacity 830 at the storage device 170. Capacity monitor 902 can count the amount of bytes, megabytes or gigabytes of available and occupied storage capacity and keep track of available capacity 830. Capacity monitor 902 can continuously or periodically update the available capacity 830, which can be expressed in terms of bytes, megabytes or gigabytes.

Storage manager 840 can include a deletion function 842 to determine which video fragments 304 to delete and which ones to retain. Deletion function 842 can include or utilize a cost function or analyzer that can take into account of the priority score 814 and the current available capacity 830 of the storage device 170. Deletion function 842 can include a decay functionality to prevent removing too many lower priority videos when there is still enough available storage capacity 830. The cost function (C(p)) can be represented by: C(p)=Wp+Cs (p), where p is a priority score, W is weight or constant to apply to weigh a value (such as 1-5), and Cs(p) is a decay function. Decay function can be expressed as Cs(p)=e\hat{ }(−b (capacity) p), where b=factor for available capacity 830, and represents the available space for storage. The exponential term can be inversely proportional to the available capacity 830, such that it is larger for a smaller amount of available capacity 830 and smaller for a larger amount of available capacity 830. As a result, decay function can increase the number of video fragments 304 to delete when available capacity 830 is reduced and decrease the number of video fragments 304 to delete when available capacity 830 is increased.

Content functions 844 can include any functions or functionality for managing or controlling storage. Content functions 844 can include a delete file functions for deleting files, or create file functions for creating files. Content functions 844 can include functionalities for saving storage space by summarizing videos of particular events or pruning video frames that are duplicative or redundant with respect to the content they provide.

Content functions 844 can include summarization function 904, which can include a combination of hardware and software for summarizing video files corresponding to an event or a time period (e.g., one or more time intervals 308). Summarization function 904 can include the functionality for selecting video fragments 304 to create a composite video 372 pertaining to a particular event or time period, such that only a subset of video fragments 304 (e.g., one or more video frames 410 are used), rather than all of the video fragments 304 of the event.

Content functions 844 can include a pruning function 906 that can include any combination of hardware and software for removing duplicate or redundant video fragments 304. For instance, if a first video fragment 304 captures a particular event or occurrence directly (e.g., within its field of view) other video fragments 304 of the same time interval 308 that did not have the event in the field of view can be removed or deleted, preserving only the most relevant video fragment 304.

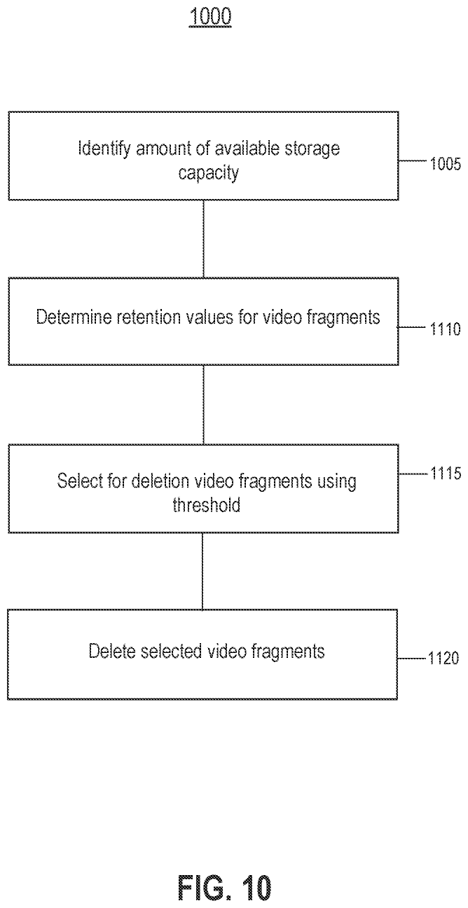

FIG. 10 illustrates an example flow diagram of a method 1000 of managing available capacity of a storage device while protecting from deletion video fragments of higher priority using a scoring system based on data of the vehicle and the available capacity. Method 1000 can be implemented, for example, using example systems 800 or 900 along with any features or functionalities discussed in connection with other figures discussed herein. Method 1000 can include ACTS 1105-1120. At 1105, an amount of available storage capacity can be identified. At 1110, retention values for video fragments can be determined. At 1115, video fragments can be selected for deletion using threshold. At 1120, selected video fragments can be deleted.

At 1105, an amount of available storage capacity can be identified. The method can include the one or more processors coupled with memory identifying an amount of available capacity of a storage device of a vehicle. The storage device can store a plurality of video fragments of one or more videos taken from the vehicle. Each of the plurality of video fragments can be assigned a priority score. The amount of available capacity can include an amount of unoccupied or available storage or memory (e.g., bytes or bits) of a storage device that can be used to store video files or video fragments. Each of the videos can include a plurality of video fragments having a metadata of the video fragment. Each of the video fragments can correspond to a different time interval of the video of a given camera of the vehicle.

The method can include the one or more processors determining, for each of the plurality of video fragments of a video file, the priority score. The priority score of a video fragment can be determined based at least on data of the vehicle corresponding to a time interval of the respective video fragment. The data of the vehicle can include any EV data, including any sensor measurement (e.g., of jerk intensity, G-force, acceleration, deceleration or impact), mode or gear of the vehicle or any information about the operation of the vehicle during the time interval. The priority score can be determined based on the scene or scene type detected by an AI or ML model in the frames of the video fragment. One or more scenes or scene types can be preferred over others and can be factored into the priority score to preserve or retain video fragments with particular scene types over video fragments with other scene types.

The method can include the one or more processors identifying, for each of the plurality of video fragments, a time interval of the respective video fragment. The time interval can be a time duration of anywhere between 1 and 30 seconds, such as for example 3 seconds of video. The method can include the one or more processors identifying for the time interval, data of the vehicle corresponding to a measurement of a sensor of the vehicle during the time interval. The measurement can include a measurement of jerk intensity, G-force, acceleration, deceleration, velocity, momentum or change in momentum, temperature, pressure, vibration or location of the vehicle. The method can include the one or more processors determining the priority score for the respective video fragment based at least on the measurement of the sensor. For example, the priority score can be given a higher priority in response to a measurement of the jerk intensity, G-force, acceleration, deceleration, velocity, momentum, change in momentum, temperature, pressure vibration or location of the vehicle exceeding or falling below a threshold. The method can include the one or more processors storing the respective priority score for each of the plurality of video fragments in a respective metadata of the respective video fragment.

At 1110, retention values for video fragments can be determined. The method can include the one or more processors determining, for each of the plurality of video fragments, a retention value based on the priority score of the respective video fragment and the amount of available capacity. For example, the data processing system can determine for each video fragment stored in the storage a retention value based on the priority score that can be weighted with a weighing parameter and a current amount of available capacity expressed as a function.

For example, the one or more processors can determine, for each of the plurality of video fragments, the retention value using a function whose exponent is negative. The retention value can be based on the priority score of the respective video fragment and the amount of available capacity. The function can be configured to decrease the retention value for a video fragment of the plurality of video fragments as the amount of available capacity is decreased.

At 1115, video fragments can be selected for deletion using threshold. The method can include selecting for deletion, by the one or more processors, at least one of the plurality of video fragments whose respective retention value does not exceed a threshold for retention. The method can include selecting for deletion all of the video fragments below the threshold for retention. The threshold can be determined based on the available capacity. For example, the threshold for retention can be increased to increase the number of video fragments to delete in response to the amount of available storage falling below a threshold amount.

The method can include the one or more processors identifying a subset of the plurality of video fragments. Each video fragment of the subset can correspond to a same time interval and have a respective retention value exceeding the threshold for retention. The one or more processors can determine, based on each video fragment of the subset input into a model trained on a data of a plurality of scenes, a type of scene for each respective video fragment of the subset. The one or more processors can select for deletion at least one of the subset of the plurality of video fragments based at least on the type of scene of the at least one of the subset of the plurality of video fragments.

At 1120, selected video fragments can be deleted. The method can include the one or more processors deleting, from the storage device, the at least one of the plurality of video fragments to increase the available capacity of the storage device. The one or more processors can delete all the video fragments whose retention value is below the threshold for retention. The one or more processors can include, for example, instructions from an operating system marking the memory locations of the video fragments whose retention value is below the threshold as deleted and designate them as available capacity (e.g., free space) of the storage device.

The method can include selecting, by the one or more processors, a subset of the plurality of video fragments. Each video fragment of the subset can include a respective retention value exceeding the threshold for retention and corresponds to a time interval within which one or more sensors of the vehicle measured one of a G-force or a jerk intensity of the vehicle exceeding a threshold. The one or more processors can generate a video of an event using the subset of the plurality of video fragments.

The method can include the one or more processors can identifying a subset of the plurality of video fragments having retention values exceeding the retention threshold and corresponding to an event. The one or more processors can select, based on the subset of the plurality of video fragments input into a model trained on a data of a plurality of scenes, a second subset of subset of the plurality of video fragments having a type of scene corresponding to the event. The one or more processors can generate a composite video of the event using the second subset.

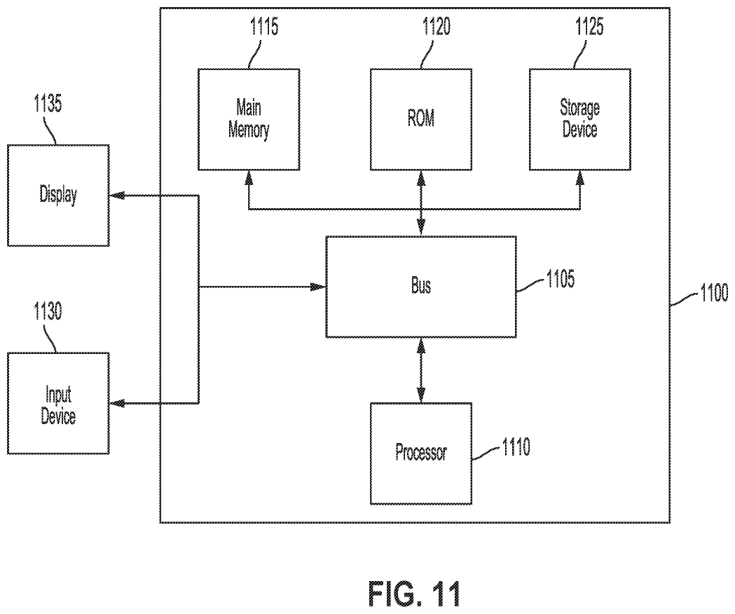

FIG. 11 depicts an example block diagram of an example computer system 1100, which can also be referred to as a computing system 1100 or computing device 1100. The computer system or computing device 1100 can include or be used to implement a data processing system 202 or its components, such as scene model 216, content model 210, fragment analyzer 330, media referencing function 370, scoring system 810, storage manager 840 and others. The computing system 1100 includes at least one bus 1105 or other communication component for communicating information and at least one processor 1110 or processing circuit coupled to the bus 1105 for processing information. The computing system 1100 can also include one or more processors 1110 or processing circuits coupled to the bus for processing information. The computing system 1100 also includes at least one main memory 1115, such as a random access memory (RAM) or other dynamic storage device, coupled to the bus 1105 for storing information, and instructions to be executed by the processor 1110. The main memory 1115 can be used for storing information during execution of instructions by the processor 1110. The computing system 1100 may further include at least one read only memory (ROM) 1120 or other static storage device coupled to the bus 1105 for storing static information and instructions for the processor 1110. A storage device 1125, such as a solid state device, magnetic disk or optical disk, can be coupled to the bus 1105 to persistently store information and instructions.

The computing system 1100 may be coupled via the bus 1105 to a display 1135, such as a liquid crystal display, or active matrix display, for displaying information to a user such as a driver of the electric vehicle 105 or other end user. An input device 1130, such as a keyboard or voice interface may be coupled to the bus 1105 for communicating information and commands to the processor 1110. The input device 1130 can include a touch screen display 1135. The input device 1130 can also include a cursor control, such as a mouse, a trackball, or cursor direction keys, for communicating direction information and command selections to the processor 1110 and for controlling cursor movement on the display 1135.

The processes, systems and methods described herein can be implemented by the computing system 1100 in response to the processor 1110 executing an arrangement of instructions contained in main memory 1115. Such instructions can be read into main memory 1115 from another computer-readable medium, such as the storage device 1125. Execution of the arrangement of instructions contained in main memory 1115 causes the computing system 1100 to perform the illustrative processes described herein. One or more processors in a multi-processing arrangement may also be employed to execute the instructions contained in main memory 1115. Hard-wired circuitry can be used in place of or in combination with software instructions together with the systems and methods described herein. Systems and methods described herein are not limited to any specific combination of hardware circuitry and software.

Although an example computing system has been described in FIG. 11, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, a computer system 1100 described in FIG. 11 can be used in conjunction with, instead of, or together with example systems 200, 300, 800 or 900 or their system components, and vice versa. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A data processing system, comprising:
one or more processors coupled with memory to:
identify a plurality of videos taken from a vehicle, each video of the plurality of videos captured between a first time and a second time;
identify, for the plurality of videos, a plurality of video fragments, each video fragment of the plurality of video fragments corresponding to data of the vehicle at a time interval of a plurality of time intervals between the first time and the second time for each video of the plurality of videos;
determine, based on the plurality of video fragments input into a model trained on a data of a plurality of scenes, a type of scene for each video fragment of the plurality of video fragments;
select, a set of video fragments based on the respective data and the respective type of scene of a plurality of sets of video fragments; and
generate a composite video using the set of video fragments.

2. The system of claim 1, wherein each video of the plurality of videos is captured by a camera of a plurality of cameras of the vehicle, each of the plurality of cameras turned to a direction different from a direction of each other of the plurality of cameras.

3. The system of claim 1, wherein the one or more processors are configured to:
determine that a drive session is complete; and
identify, responsive to the determination that the drive session is complete, the plurality of videos of the drive session captured by a plurality of cameras of the vehicle.

4. The system of claim 1, wherein the one or more processors are configured to:
generate, for each video fragment of each set of video fragments of the plurality of sets of video fragments, a score determined according to the data and the type of scene of the respective video fragment;
select, for each respective set of video fragments, a selected video fragment of the respective set according to the score of the selected video fragment.

5. The system of claim 1, wherein the one or more processors are configured to:
select for a plurality of sets of video fragments corresponding to at least a subset of the plurality of time intervals; and
generate the composite video using the set of video fragments corresponding to the at least a subset of the plurality of time intervals.

6. The system of claim 1, wherein each of the plurality of sets of video fragments includes a plurality of video fragments from the plurality of videos captured by a plurality of cameras, each of the plurality of sets of video fragments corresponding to a different time interval of the plurality of time intervals between the first time and the second time.

7. The system of claim 1, wherein the one or more processors are configured to:
identify a feature of the composite video;
determine, based at least on the composite video input into a model trained using machine learning on a data comprising a plurality of features in the plurality of scenes, a scene of the composite video corresponding to the feature;
select, based on the scene, content to insert into the composite video; and
provide, for display, the composite video including the content.

8. The system of claim 7, wherein the one or more processors are configured to:
identify data of the vehicle corresponding to a fragment of the composite video;
select, based on the data and the scene, the content to insert into the composite video.

9. The system of claim 7, wherein the one or more processors are configured to:
identify a location of the feature in a frame of the composite video; and
insert the content into the frame of the composite video according to the location of the feature.

10. The system of claim 7, wherein the one or more processors are configured to:
generate, based at least on the scene input into a second model trained using machine learning on data comprising a plurality of contents, the content to insert into the composite video; and
select the content responsive to the generating.

11. A method, comprising:
identifying, by one or more processors coupled with memory, a plurality of videos taken from a vehicle, each video of the plurality of videos captured between a first time and a second time;
identifying, by the one or more processors for the plurality of videos, a plurality of video fragments, each video fragment of the plurality of video fragments corresponding to data of the vehicle at a time interval of a plurality of time intervals between the first time and the second time for each video of the plurality of videos;
determining, by the one or more processors, based on the plurality of video fragments input into a model trained on a data of a plurality of scenes, a type of scene for each video fragment of the plurality of video fragments;
selecting, by the one or more processors, a set of video fragments based on the respective data and the respective type of scene of a plurality of sets of video fragments; and
generating, by the one or more processors, a composite video using the set of video fragments.

12. The method of claim 11, wherein each video of the plurality of videos is captured by a camera of a plurality of cameras of the vehicle, each of the plurality of cameras turned to a direction different from a direction of each other of the plurality of cameras.

13. The method of claim 11, comprising:
determining, by the one or more processors, that a drive session is complete; and
identifying, by the one or more processors, responsive to the determination that the drive session is complete, the plurality of videos of the drive session captured by a plurality of cameras of the vehicle.

14. The method of claim 11, comprising:
generating, by the one or more processors, for each video fragment of each set of video fragments of the plurality of sets of video fragments, a score determined according to the data and the type of scene of the respective video fragment;
selecting, by the one or more processors, for each respective set of video fragments, a selected video fragment of the respective set according to the score of the selected video fragment.

15. The method of claim 11, comprising:
selecting, by the one or more processors for a plurality of sets of video fragments corresponding to at least a subset of the plurality of time intervals, the set of video fragments, each selected video fragment of the selected set of video fragments corresponding to a time interval of the subset of the plurality of time intervals; and
generating, by the one or more processors, the composite video corresponding to the subset of the plurality of time intervals using the set of video fragments.

16. The method of claim 11, wherein each of the plurality of sets of video fragments includes a plurality of video fragments from the plurality of videos captured by a plurality of cameras, each of the plurality of sets of video fragments corresponding to a different time interval of the plurality of time intervals between the first time and the second time.

17. The method of claim 11, comprising:
identifying, by the one or more processors, a feature of the composite video;
determining, by the one or more processors based at least on the composite video input into a model trained using machine learning on a data comprising a plurality of features in the plurality of scenes, a scene of the composite video corresponding to the feature;
selecting, by the one or more processors based on the scene, content to insert into the composite video; and
providing, by the one or more processors for display, the composite video including the content.

18. The method of claim 17, comprising:
identifying, by the one or more processors data of the vehicle corresponding to a fragment of the composite video;
selecting, by the one or more processors based on the data and the scene, the content to insert into the composite video.

19. The method of claim 17, comprising:
identifying, by the one or more processors a location of the feature in a frame of the composite video;
generate, based at least on the scene input into a second model trained using machine learning on data comprising a plurality of contents, the content to insert into the composite video; and
select the content responsive to the generating;
inserting, by the one or more processors, the content into the frame of the composite video according to the location of the feature.

20. A non-transitory computer-readable media having processor readable instructions, such that, when executed, cause a processor to:
identify a plurality of videos taken from a vehicle, each video of the plurality of videos captured between a first time and a second time;
identify, for the plurality of videos, a plurality of video fragments, each video fragment of the plurality of video fragments corresponding to data of the vehicle at a time interval of a plurality of time intervals between the first time and the second time for each video of the plurality of videos;
determine, based on the plurality of video fragments input into a model trained on a data of a plurality of scenes, a type of scene for each video fragment of the plurality of video fragments;
select, a set of video fragments based on the respective data and the respective type of scene of a plurality of sets of video fragments; and
generate a composite video using the set of video fragments.
